(19) United States
(12) Patent Application Publication
(10) Pub. No.: US 2005/0217450 A1
(43) Pub. Date: Oct. 6, 2005

(54) Foot Frame

(76) Inventor: Jewel Tracy, Minneapolis, MN (US)

Correspondence Address: Roger L. Belfay, 829 Tuscarora Avenue, Saint Paul, MN, 55102, US

(21) Appl. No.: 10/814,504

(22) Filed: Mar. 31, 2004

(51) Int. Cl. B26D 7/00

(52) U.S. Cl. 83/649; 83/949

(57) ABSTRACT

The Foot Frame is a device to dispense from a supply of sanitary covering material and for positioning said sanitary covering material on any floor to provide a sanitary area for a user to stand when footwear has been removed comprising; a frame having a first, second, third, and fourth side, for placement on a floor to define said sanitary area and guide said sanitary covering material through said sanitary area, and a dispensing device to supply said sanitary covering material with said dispensing device disposed above said frame, attached to said first side of said frame, and outside of said sanitary area.

### SPECIFICATION The Foot Frame is a device to dispense from a supply of sanitary covering material and for positioning said sanitary covering material on any floor to provide a sanitary area for a user to stand when footwear has been removed comprising: a frame having a first, second, third, and fourth side, for placement on a floor to define said sanitary area and guide said sanitary covering material through said frame and a dispensing device to supply said sanitary covering material with said dispensing device disposed above said frame, attached to said first side of said frame, and outside of said sanitary area. Optionally, the Foot Frame also includes a collection device to collect said sanitary covering material with said collection device disposed above said frame, attached to said third side of said frame and outside said sanitary area.

The sanitary covering material should be advanced through the guide after each user dismounts the Foot Frame to provide a new sanitary area for the next user. The optional collection mechanism may be provided with a powered means for collecting expended sanitary covering material. Motion, infrared, laser, or weight sensors may be employed to detect dismount of each user and thereby cause automatic collection of the sanitary covering material and preparation of a newly sanitized surface for the next user.

### TITLE

Foot Frame

### CROSS REFERENCE TO RELATED APPLICATIONS

There are no applications related to this application.

### STATEMENT REGARDING FEDERAL SPONSORSHIP

No invention claimed in this application was made under Federally sponsored research or development.

### BACKGROUND OF INVENTION

There are a number of inventions providing a sanitary covering for medical examination tables, chiropractic treatment tables, and even hospital beds. The current need for security in accessing public transportation, most notably in the airline industry has created a need to permit examination of the footwear of prospective passengers. This need, in turn results in a need for prospective passengers to remove their footwear in public places and stand barefooted on areas previously occupied by their barefooted predecessors. The implications of this fact of modern life for the spread of communicable diseases of the foot inspires a need to provide freshly sanitized standing areas for prospective passengers while their footwear is scrutinized.

This invention addresses that need by providing a novel configuration of sanitized covering dispenser and a guiding frame to identify such an area and provide a means of replenishing the sanitized covering for each prospective passenger. Since prospective passengers-wait in a standing position on a floor, as opposed to an examination table or bed the configuration of the Foot Frame is configured for use on floors as opposed to on tables. This anticipated use implies that the sanitary covering material used by the Foot Frame must be dispensed from above the users contact position.

In examination and medical treatment tables, the sanitary covering material has historically been dispensed and collected by mechanisms place below and under the user contact surface to keep the mechanisms out of the way and out of site. In the case of medical bedding the practice has been the same for the same reasons.

Because the Foot Frame is used at floor level, use of dispensing and collecting mechanisms below the user contact surface is generally impractical and at the least would result in a step up approach for the user upon entry to the sanitary area and a step down upon egress from the sanitized area.

### BRIEF SUMMARY OF THE INVENTION

The Foot Frame is a device to dispense from a supply of sanitary covering material and for positioning said sanitary covering material on any floor to provide a sanitary area for a user to stand when footwear has been removed comprising: a frame having a first, second, third, and fourth side, for placement on a floor to define said sanitary area and guide said sanitary covering material through said frame and a dispensing device to supply said sanitary covering material with said dispensing device disposed above said frame, attached to said first side of said frame, and outside of said sanitary area. Optionally, the Foot Frame also includes a collection device to collect said sanitary covering material with said collection device disposed above said frame, attached to said third side of said frame and outside said sanitary area.

The placement of the dispensing and collection mechanisms above the user surface allows the Foot Frame to be used on the floor of any area where persons must remove footwear and stand for a period of time without said footwear.

### BRIEF DESCRIPTION OF THE DRAWINGS

FIG. 1 is a plan view of a Foot Frame.

FIG. 2 is a front view of FIG. 1.

FIG. 3 is a sectional view of FIG. 1.

FIG. 4 is a first embodiment of a Foot Frame.

FIG. 5 is a front view of FIG. 4.

FIG. 6 is a sectional view of FIG. 4.

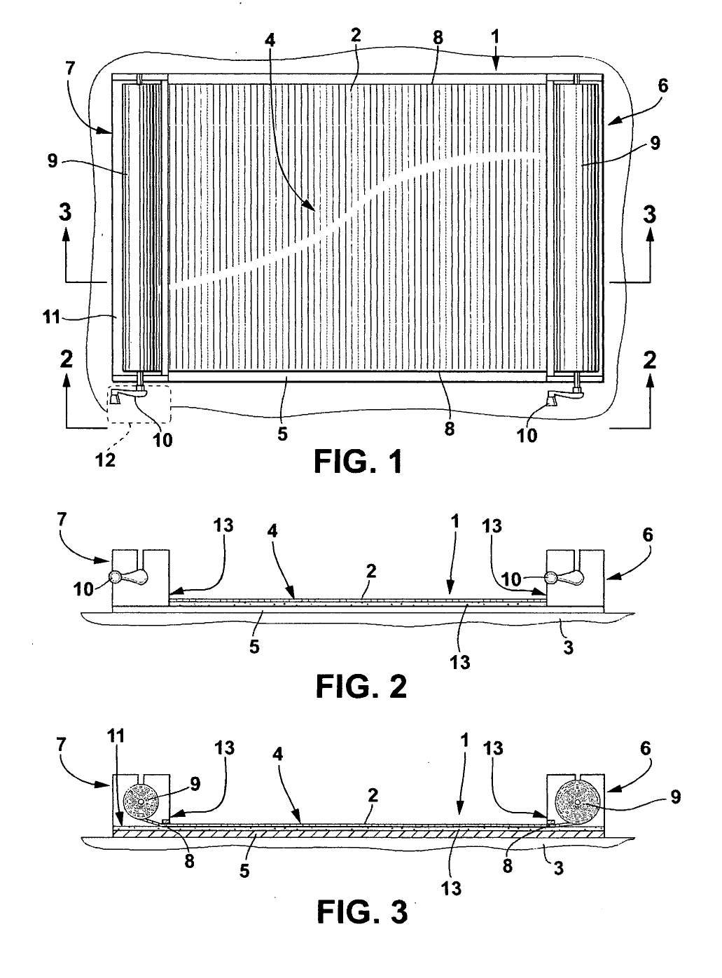

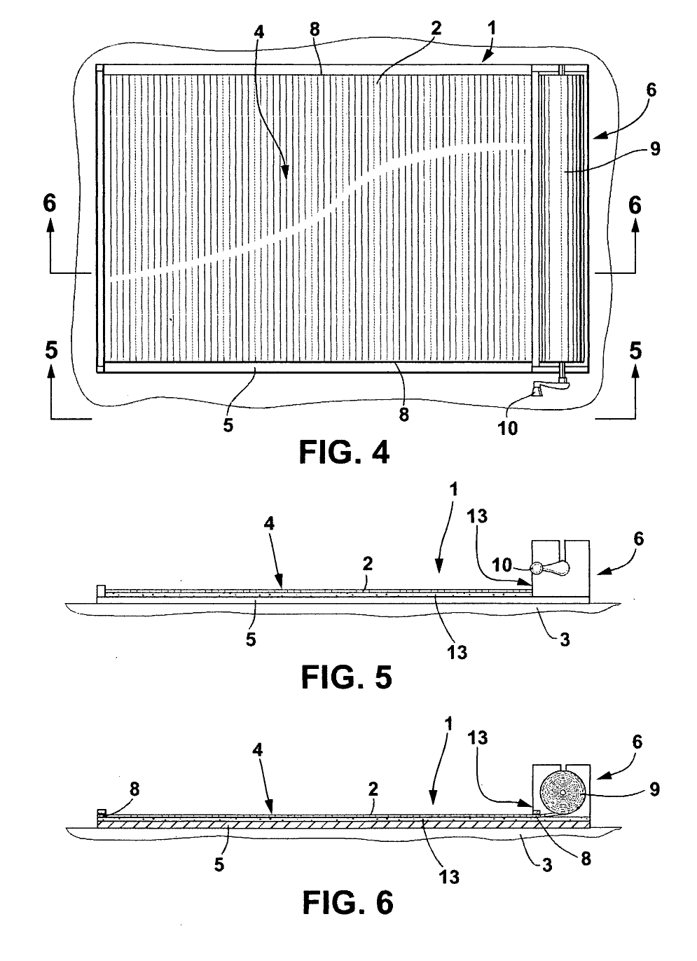

### DETAILED DESCRIPTION

The Foot Frame 1 is a device to dispense from a supply of sanitary covering material 2 and for positioning said sanitary covering material 2 on any floor 3 to provide a sanitary area 4 for a user to stand when footwear has been removed comprising: a frame 5 having a first, second, third, and fourth side, for placement on a floor 3 to define said sanitary area 4 and guide said sanitary covering material 2 through said frame 5 and a dispensing device 6 to supply said sanitary covering material 2 with said dispensing device 6 disposed above said frame 5, attached to said first side of said frame 5, and outside of said sanitary area 4. Optionally, the Foot Frame 1 also includes a collection device 7 to collect said sanitary covering material 2 with said collection device 7 disposed above said frame 5, attached to said third side of said frame 5 and outside said sanitary area 4. While it will be appreciated that the Foot Frame 1 may be created in a large number of physical configurations, a rectangular configuration of the Foot Frame 1 may be created by placing a frame 5 approximately 18 inches by 24 inches on a flat surface such as a floor 3 defining the sanitary area 4 for the user. The frame 5 may have any number of sides but in the rectangular application the frame 5 would be rectangular with two opposing sides having guide slots 8 to guide the sanitary covering material 2 across the sanitary area 4. In the rectangular configuration the sanitary covering material 2 dispensing device 6 is attached to a first side perpendicular to the guide slots 8. Optionally, in the rectangular configuration, a sanitary covering material 2 collection device 7 is attached to a second side of the frame 5 opposite the first side. The dispensing device 6 may be a roller assembly 9 with an optional hand crank 10 to roll or unroll sanitary covering material 2 provided in a rolled up configuration. The dispensing device 6 may also be a surface area 11 for placing sanitary covering material 2, possibly in a fan-fold configuration. The collection device 7 may be a roller assembly 9 with an optional hand crank 10 to roll or unroll sanitary covering material 2 provided in a rolled up configuration.

The collection device 7 may also be a surface areal 1 for placing sanitary covering material 2, possibly in a fan-fold configuration.

The sanitary covering material 2 may be a sanitary paper typically used in medical facilities on examining tables, however it will be readily appreciated that plastic or other materials are equally suitable. A material which adheres to the floor 3 surface on which the Foot Frame 1 will be used should be chosen to minimize any propensity for the user to slip and fall when mounting or dismounting the Foot Frame 1.

The sanitary covering material 2 should be advanced through the guide after each user dismounts the Foot Frame 1 to provide a sanitary area 4 for the next user. The optional collection device 7 may be provided with a powered means 12 for collecting expended sanitary covering material 2. Motion, infrared, laser, or weight sensors 13 may be employed to detect the dismount of each user and thereby cause automatic collection of the sanitary covering material 2 and preparation of a fresh sanitary area 4 for the next user.

1) A device to dispense from a supply of sanitary covering material and for positioning said sanitary covering material on any floor to provide a sanitary area for a user to stand when footwear has been removed comprising:
(a) A frame having a first, second, third, and fourth side, for placement on a floor to define said sanitary area and guide said sanitary covering material through said frame;
(b) A dispensing device to supply said sanitary covering material with said dispensing device disposed above said frame, attached to said first side of said frame, and outside of said sanitary area;

2) The device of claim 1 further comprising a collection device to collect said sanitary covering material with said collection device disposed above said frame, attached to said third side of said frame and outside said sanitary area.

3) The device of claim 1 wherein said third side of said frame includes a cutting means to sever used segments of said sanitary covering material.

4) The device of claim 1 wherein the sanitary material is perforated to facilitate removal of used portions of said sanitary covering material.

5) The device of claim 1 wherein the dispensing device comprises a stacking area for perforated sheets of said sanitary covering material.

6) The device of claim 2 wherein the collection device is a hand operated roller with a means for attaching the end of said sanitary covering material.

7) The device of claim 6 wherein the collection device is an electrically operated roller.

8) The device of claim 7 further comprising; a sensor that activates the electrically powered roller to remove the used portion of the sanitary covering material whenever the user vacates the sanitary area.
